(19) United States
(12) Patent Application Publication
(10) Pub. No.: US 2021/0208897 A1
(43) Pub. Date: Jul. 8, 2021

(54) SETTING METHOD, SYSTEM, DEVICE AND COMPUTER READABLE MEDIUM OF CONFIGURATION OF MAINBOARD EXPANSION SLOT

(71) Applicants: INVENTEC (PUDONG) TECHNOLOGY CORPORATION, Shanghai City (CN); INVENTEC CORPORATION, Taipei City (TW)

(72) Inventors: Jin CHEN, Shanghai City (CN); Yu-Xi CHEN, Shanghai City (CN)

(73) Assignees: INVENTEC (PUDONG) TECHNOLOGY CORPORATION, Shanghai City (CN); INVENTEC CORPORATION, Taipei City (TW)

(21) Appl. No.: 16/796,685

(22) Filed: Feb. 20, 2020

(30) Foreign Application Priority Data
Jan. 2, 2020 (CN) 202010001556.8

(51) Int. Cl. G06F 9/4401

(52) U.S. Cl. CPC G06F 9/4401

(57) ABSTRACT

A setting method, system, device and a computer readable medium of a configuration of a PCIE slot (mainboard expansion slot). The setting method comprises: determining whether the configuration of the mainboard expansion slot is an automatic setting, performing the setting of the configuration of the mainboard expansion slot based on a first preset rule when the configuration of the mainboard expansion slot is the automatic setting, and performing the setting of the configuration of the mainboard expansion slot based on a default value when the configuration of the mainboard expansion slot is not the automatic setting. A setting method, system, device and a computer readable medium of a configuration of the present disclosure may perform the setting of the configuration of the mainboard expansion slot when the configuration of the mainboard expansion slot is the automatic setting, without another reboot from a basic input/output system (BIOS).

### CROSS-REFERENCE TO RELATED APPLICATIONS

This non-provisional application claims priority under 35 U.S.C. § 119(a) on Patent Application No(s). 202010001556.8 filed in China on Jan. 2, 2020, the entire contents of which are hereby incorporated by reference.

### BACKGROUND

### 1. Technical Field

This disclosure relates to the field of communication technology, particularly to a method, system, device and a computer readable medium for a configuration of a PCIE slot (mainboard expansion slot).

### 2. Related Art

When the previous configuration of a mainboard expansion slot was set to be automatic, it was actually one of the five settings (X16/X8×8/X4×4×8/X8×4×4/X4×4×4×4), which did not achieve the meaning of the automation. There are two main implementation methods for the automatic adjustment of the configuration of the mainboard expansion slot, one is to set it according to the information of baseboard management controller (BMC) field replaceable unit (FRU); the other one is to set it according to the bandwidth of the identified device. The disadvantage is that the BIOS (basic input/output system) cannot obtain FRU information and identify the device until the middle of the implementation. This results in the BIOS needing to reactivate and reading FRU has be performed under the circumstance that BMC works normally after the configuration of the mainboard expansion slot is set.

Therefore, it is hoped to solve the problem of how to automatically set the configuration the of the mainboard expansion slot, without the need to reactive the BIOS.

### SUMMARY

According to one or more embodiment of this disclosure, a setting method of configuration of mainboard expansion slot, comprising: determining whether a configuration of a mainboard expansion slot is an automatic setting; performing the setting of the configuration of the mainboard expansion slot based on a first preset rule when the configuration of the mainboard expansion slot is the automatic setting; and performing the setting of the configuration of the mainboard expansion slot based on a default value when the configuration of the mainboard expansion slot is not the automatic setting.

According to one embodiment of this disclosure, wherein performing the setting of the configuration of the mainboard expansion slot based on the first preset rule comprises: reading values of three general-purpose input/output (GPIO) ports of the mainboard expansion slot by a basic input/output system (BIOS); and setting the configuration of the mainboard expansion slot based on a second preset rule according to the values of the three GPIO ports.

According to one embodiment of this disclosure, wherein the configuration of the mainboard expansion slot comprises five candidate configurations, the five candidate configurations comprises X16, X8×8, X4×4×8, X8×4×4, and X4×4×4×4, and the configuration of the mainboard expansion slot is one of the five candidate configurations.

According to one embodiment of this disclosure, wherein the second preset rule is: the configurations X16, X8×8, X4×4×8, X8×4×4, and X4×4×4×4 of the mainboard expansion slot respectively correspond to five different values, each of the five different values is a three-digit binary value, and the value of one of the three GPIO ports is one of the five different values.

According to one or more embodiment of this disclosure, a setting system of configuration of mainboard expansion slot, comprising: an automatic setting determination module, configured to determine whether a configuration of a mainboard expansion slot is an automatic setting; a first setting module, configured to perform the setting of the configuration of the mainboard expansion slot based on a first preset rule when the configuration of the mainboard expansion slot is the automatic setting; and a second setting module, configured to perform the setting of the configuration of the mainboard expansion slot based on a default value when the configuration of the mainboard expansion slot is not the automatic setting.

According to one embodiment of this disclosure, wherein the first setting module is further configured to: read values of three general-purpose input/output (GPIO) ports of the mainboard expansion slot by a basic input/output system (BIOS), and set the configuration of the mainboard expansion slot based on a second preset rule according to the values of the three GPIO ports.

According to one embodiment of this disclosure, wherein the configuration of the mainboard expansion slot comprises five candidate configurations, the five candidate configurations comprises X16, X8×8, X4×4×8, X8×4×4, and X4×4×4×4, and the configuration of the mainboard expansion slot is one of the five candidate configurations.

According to one embodiment of this disclosure, wherein the second preset rule is: the configurations X16, X8×8, X4×4×8, X8×4×4, and X4×4×4×4 of the mainboard expansion slot respectively correspond to five different values, each of the five different values is a three-digit binary value, and the value of one of the three GPIO ports is one of the five different values.

According to one or more embodiment of this disclosure, a computer readable medium, stores a computer program, wherein the computer program is executed by a processor, to execute any one of the setting methods of the configuration of the mainboard expansion slot described above.

According to one or more embodiment of this disclosure, a setting device of configuration of mainboard expansion slot, comprising: a memory, configured to store a computer program; and a processor, connected to the memory, wherein the processor is configured to execute the computer program stored in the memory, so that the setting device of configuration of mainboard expansion slot executes any one of the setting methods of the configuration of the mainboard expansion slot described above.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1a is a flow chart of a setting method of the configuration of the mainboard expansion slot (PCIE slot) according to one embodiment of the present disclosure;

FIG. 1b is a flow chart of a setting method of the configuration of the mainboard expansion slot (PCIE slot) according to one embodiment of the present disclosure;

FIG. 2 is a block diagram of a setting system of the configuration of the mainboard expansion slot (PCIE slot) according to one embodiment of the present disclosure; and

FIG. 3 is a block diagram of a setting device of the configuration of the mainboard expansion slot (PCIE slot) according to one embodiment of the present disclosure.

### DETAILED DESCRIPTION

It should be noted that, the illustrations provided in the following embodiments merely illustrate the basic concept of the present disclosure in a schematic manner. Therefore, only the components related to the present disclosure are shown in the drawings, instead of the number, shape and size of components according to actual implementation. In actual implementation, the type, quantity and proportion of each component can be a random alteration, and the configuration of the components can be more complicated.

The setting method, system, device and a readable medium of a configuration of a mainboard expansion slot (PCIE slot) of the present disclosure enable the completion of the setting of the configuration of the mainboard expansion slot when the setting of the configuration of the mainboard expansion slot is an automatic setting, without the need of reactivating of the BIOS, to truly achieve automatic setting.

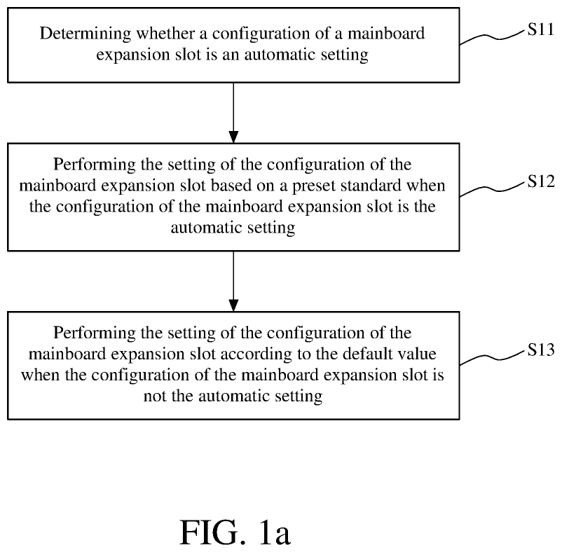

As shown in FIG. 1a, in one embodiment, the setting method of the configuration of the PCIE slot comprises the following step:

S11: determining whether the configuration of the mainboard expansion slot is an automatic setting.

Specifically, as shown in FIG. 1b, the setting method of the configuration of the PCIE slot comprises the following step: when there are N mainboard expansion slots, start the determining from the first mainboard expansion slot (N=1, N indicates the N^{th} PCIE slot). The basic input/output system (BIOS) sequentially determines whether the configuration of the mainboard expansion slot is the automatic setting (the BIOS inspects whether the N^{th} PCIE slot is set as auto). When the configuration of the mainboard expansion slot is the automatic setting, perform the setting of the configuration of the mainboard expansion slot based on a first preset rule. Read values of three general-purpose input/output (GPIO) ports of the mainboard expansion slot by the BIOS (read the value of GPIO0˜2 corresponding to the corresponding PCIE slot); set the configuration of the mainboard expansion slot based on a second preset rule according to the values of the three GPIO ports (the BIOS configures actual automatic behavior based on the value of the read GPIO0˜2). Examine whether it is the last mainboard expansion slot (PCIE slot), ends the method when it is the last mainboard expansion slot, and sets N=N+1 when it is not the last mainboard expansion slot. When the configuration of the mainboard expansion slot is not the automatic setting, perform the setting of the configuration of the mainboard expansion slot according to a default value. Examine whether it is the last PCIE slot (mainboard expansion slot), ends the method when it is the last mainboard expansion slot, and sets N=N+1 when it is not the last PCIE slot.

Specifically, the method further includes determining whether the configuration of the mainboard expansion slot is the automatic setting sequentially, meaning the number of the mainboard expansion slot is at least 1, the number of the mainboard expansion slot can be 2, 3 or more. Each of the mainboard expansion slot can also be determined based on steps S11, S12 and S13 of the present disclosure, to sequentially embody every setting of the configuration of the mainboard expansion slot. The automatic setting means that the configuration of the mainboard expansion slot is preset to be automatic. When the configuration of the mainboard expansion slot is the automatic setting, perform the setting of the configuration of the mainboard expansion slot through step S12. When the configuration of the mainboard expansion slot is not the automatic setting, perform the setting of the configuration of the mainboard expansion slot through step S13.

Step S12, when the configuration of the mainboard expansion slot is the automatic setting, perform the setting of the configuration of the mainboard expansion slot based on a preset rule.

Specifically, performing the setting of the configuration of the mainboard expansion slot based on a first preset rule includes the following steps: reading values of the three GPIO ports through the BIOS; setting the configuration of the mainboard expansion slot based on a second preset rule according to the values of the three GPIO ports. The GPIO stands for general-purpose input/output.

Specifically, the configuration of the mainboard expansion slot comprises five candidate configurations, the five candidate configurations comprises X16, X8×8, X4×4×8, X8×4×4, and X4×4×4×4, and the configuration of the mainboard expansion slot is one of the five candidate configurations. X16, X8×8, X4×4×8, X8×4×4, and X4×4×4×4 represent the specific specifications of the current configuration of the mainboard expansion slot.

Specifically, the second preset rule is: the five candidate configurations X16, X8×8, X4×4×8, X8×4×4, and X4×4×4×4 of the mainboard expansion slot respectively correspond to five different values, each of the five different values is a three-digit binary value, and the value of one of the three GPIO ports is one of the five different values. For example, the specific corresponding values are shown as below:

| | | | Configuration of the mainboard expansion |
|---|---|---|---|
| GPIO0 | GPIO1 | GPIO2 | slot |
| * | 0 | * | X16 |
| 0 | 1 | 0 | X4x4x4x4 |
| 1 | 1 | 0 | X8x4x4 |
| 0 | 1 | 1 | X4x4x8 |
| 1 | 1 | 1 | X8x8 |

The five candidate configurations X16, X8×8, X4×4×8, X8×4×4, and X4×4×4×4 of the mainboard expansion slot that respectively correspond to values of three GPIO ports are *0*, 111, 011, 110, and 010. In other words, when the configuration of the mainboard expansion slot is the automatic setting, when the value of three GPIO ports of the mainboard expansion slot read by the BIOS is *0* (meaning the third digit and the first digit can be a random value in three-digit binary system), then set the configuration of the mainboard expansion slot as X16.

Or, read values of three GPIO ports of the mainboard expansion slot based on the BIOS automatically sets the configuration of the mainboard expansion slot, the BIOS can read the values corresponding to three GPIO ports in an early stage. After the reading is completed, the actual operation mode of the mainboard expansion slot can be directly set according to the second preset rule, without the need of reactivating with the BIOS, to truly achieve automatic setting. Obviously, the five candidate configurations of the mainboard expansion slot X16, X8×8, X4×4×8, X8×4×4, and X4×4×4×4 respectively corresponding to values of three GPIO ports that being *0*, 111, 011, 110, and 010 is merely an example. The values of three GPIO ports can also be other five different values in three-digit binary system.

Step S13, when the configuration of the mainboard expansion slot is not the automatic setting, perform the setting of the configuration of the mainboard expansion slot according to the default value.

Specifically, the default value is that the configuration of the mainboard expansion slot includes one of the X16, X8×8, X4×4×8, X8×4×4, and X4×4×4×4.

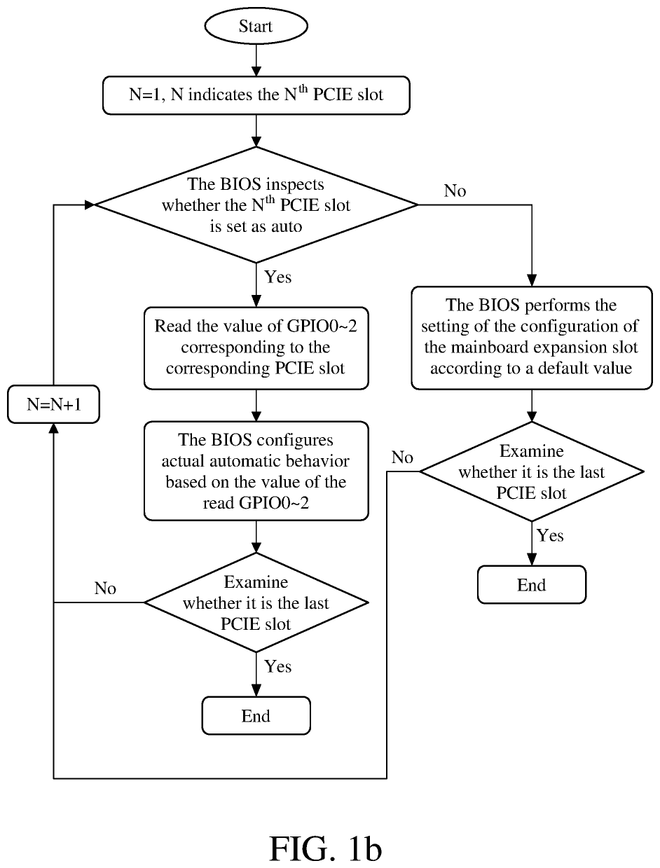

As shown in FIG. 2, in one embodiment, the setting system of the configuration of the PCIE slot of the present disclosure, comprises an automatic setting determination module 21, a first setting module 22 and a second setting module 23.

The automatic setting determination module 21 is configured to determine whether the setting of the configuration of the mainboard expansion slot is the automatic setting.

Specifically, the automatic setting determination module 21 is further configured to sequentially determine whether the configuration of the mainboard expansion slot is the automatic setting. In other words, the number of the mainboard expansion slot is at least 1, the number of the mainboard expansion slot can be 2, 3 or more. Each of the mainboard expansion slot can also be determined based on the automatic setting determination module 21, the first setting module 22 and the second setting module 23, to sequentially embody each setting of the configuration of the mainboard expansion slot. The automatic setting means that the configuration of the mainboard expansion slot is preset to be automatic. When the configuration of the mainboard expansion slot is the automatic setting, perform the setting of the configuration of the mainboard expansion slot by the first setting module 22. When the configuration of the mainboard expansion slot is not the automatic setting, perform the setting of the configuration of the mainboard expansion slot by the second setting module 23.

The first setting module 22 is configured to perform the setting of the configuration of the mainboard expansion slot based on the first preset rule when the configuration of the mainboard expansion slot is the automatic setting.

Specifically, the first setting module 22 is configured to read the values of three GPIO ports of the mainboard expansion slot through the BIOS; set the configuration of the mainboard expansion slot based on the second preset rule according to the values of three GPIO ports. The GPIO stands for general-purpose input/output.

Specifically, the configuration of the mainboard expansion slot comprises five candidate configurations, the five candidate configurations comprises X16, X8×8, X4×4×8, X8×4×4, and X4×4×4×4, and the configuration of the mainboard expansion slot is one of the five candidate configurations. X16, X8×8, X4×4×8, X8×4×4, and X4×4×4×4 represent the specific specifications of the current configuration of the mainboard expansion slot.

Specifically, the second preset rule is: the configurations X16, X8×8, X4×4×8, X8×4×4, and X4×4×4×4 of the mainboard expansion slot respectively correspond to five different values, each of the five different values is a three-digit binary value, and the value of one of the three GPIO ports is one of the five different values. For example, the specific corresponding values are shown as below:

| | | | Configuration of the mainboard expansion |
|---|---|---|---|
| GPIO0 | GPIO1 | GPIO2 | slot |
| * | 0 | * | X16 |
| 0 | 1 | 0 | X4x4x4x4 |
| 1 | 1 | 0 | X8x4x4 |
| 0 | 1 | 1 | X4x4x8 |
| 1 | 1 | 1 | X8x8 |

The five candidate configurations of the mainboard expansion slot X16, X8×8, X4×4×8, X8×4×4, and X4×4×4×4 respectively correspond to values of three GPIO ports that are *0*, 111, 011, 110, and 010. In other words, when the configuration of the mainboard expansion slot is the automatic setting, when the value of three GPIO ports of the mainboard expansion slot read by the BIOS is *0* (meaning the third digit and the first digit can be a random value in three-digit binary system), then set the configuration of the mainboard expansion slot as X16.

Or, read values of three GPIO ports of the mainboard expansion slot based on the BIOS to automatically set the configuration of the mainboard expansion slot, the BIOS can read the values corresponding to three GPIO ports in an early stage. After the reading is completed, the actual operation mode of the mainboard expansion slot can be directly set according to the second preset rule, without the need of reactivating with the BIOS, to truly achieve automatic setting. Obviously, the five candidate configurations of the mainboard expansion slot X16, X8×8, X4×4×8, X8×4×4, and X4×4×4×4 respectively corresponding to values of three GPIO ports that being *0*, 111, 011, 110, and 010 is merely an example. The values of three GPIO ports can also be other five different values in three-digit binary system.

The second setting module 23 is configured to perform the setting of the configuration of the mainboard expansion slot according to the default value when the configuration of the mainboard expansion slot is not the automatic setting.

Specifically, the default value is that the configuration of the mainboard expansion slot includes one of the X16, X8×8, X4×4×8, X8×4×4, and X4×4×4×4. Meaning, the configuration of the mainboard expansion slot is set as one of the X16, X8×8, X4×4×8, X8×4×4, and X4×4×4×4.

It should be noted that, the structures and principles of the automatic setting determination module 21, the first setting module 22, and the second setting module 23 correspond to the steps in the above-mentioned PCIE slot configuration and setting method. Therefore, they are not repeated herein.

It should be noted that, the division of each module and system above are merely a division of logical functions. In actual implementation, it can be fully or partially integrated into one or several physical entities. And these modules can be implemented entirely in software and called by processing components; they can also be implemented entirely in hardware; they can further be implemented partially in the form of software called by processing components, and partially in the form of hardware. For example, the x module can be a processing component established separately, or it can be integrated into one of the chips of the device described above. Besides, it can also be stored in the form of a program code in the memory of the device described above, and the function of the x module can be called and executed by a processing component of the device described above. The implementation of other modules is similar. In addition, these modules can be integrated fully or partially, they can also be implemented independently. The processing component described here can be an integrated circuit, and has the ability of processing signals. In the process of implementation, each step or module in the above method can be completed by the integrated logic circuits of the processing component or commands in the form of software.

For example, these modules can be one or more integrated circuits configured to implement the above methods, for example, one or more application specific integrated circuits (ASIC), or, one or more digital signal processors (DSP), or, one or more field programmable gate arrays (FPGA). As another example, when one of the above modules is implemented in the form of program code called by the processing component, the processing component can be a general-purpose processor, such as a central processing unit (CPU) or other processing component that can call the program code. As another example, these modules can be integrated together and implemented in the form of a system-on-a-chip (SOC).

In an embodiment of the present disclosure, the present disclosure further comprises a computer readable medium, which stores a computer program. The computer program implements any one of the setting methods of the configuration of the PCIE slot (mainboard expansion slot) described above when executed by a processor.

A person skilled in the art may understand that all or part of the steps for implementing the foregoing method embodiments may be completed by computer program related hardware. The aforementioned computer program can be stored in the computer readable medium. When the program is executed, the steps including the foregoing method embodiments are performed; and the aforementioned computer readable medium comprises: a read-only memory (ROM), a random access memory (RAM), a magnetic disk or an optic disk, and other media that can store program codes.

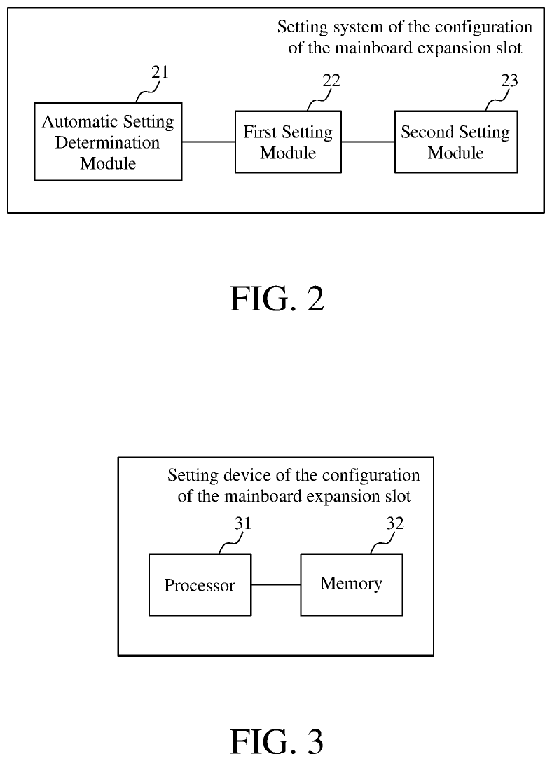

As shown in FIG. 3, in one embodiment, the setting device of the configuration of the PCIE slot (mainboard expansion slot) comprises: a processor 31 and a memory 32; the memory 32 is configured to store a computer program; the processor 31 and the memory 32 are connected to each other, configured to execute the computer program stored in the memory 32, so that the setting device of the configuration of the PCIE slot can execute any one of the setting methods of the configuration of the PCIE slot.

Specifically, the memory 32 includes: ROM, RAM, magnetic disk, USB memory, memory card, optic disk or other medium that can be used to store the program code.

Preferably, the processor 31 can be a general-purpose processor, including a central processing unit (CPU), a network processor (NP); it can also be a digital signal processor (DSP), application specific integrated circuit (ASIC), a field programmable gate array (FPGA) or other programmable logic unit, discrete gate component or transistor logic unit, discrete hardware component.

In view of the above description, the setting method, system, device and readable medium of the configuration of the mainboard expansion slot (PCIE slot) of the present disclosure may perform the setting of the configuration of the mainboard expansion slot when the setting of the configuration of the mainboard expansion slot is automatic, without the need of reactivating with the BIOS, to truly achieve the automatic setting. Therefore, the present disclosure effectively overcomes various shortcomings in the prior art and has high industrial utilization value.

The present disclosure has been disclosed above in the embodiments described above, however it is not intended to limit the present disclosure. It is within the scope of the present disclosure to be modified without deviating from the essence and scope of it. It is intended that the scope of the present disclosure is defined by the following claims and their equivalents.

What is claimed is:

1. A setting method of configuration of mainboard expansion slot, comprising:
determining whether a configuration of a mainboard expansion slot is an automatic setting;
performing the setting of the configuration of the mainboard expansion slot based on a first preset rule when the configuration of the mainboard expansion slot is the automatic setting; and
performing the setting of the configuration of the mainboard expansion slot based on a default value when the configuration of the mainboard expansion slot is not the automatic setting.

2. The setting method of configuration of mainboard expansion slot according to claim 1, wherein performing the setting of the configuration of the mainboard expansion slot based on the first preset rule comprises:
reading values of three general-purpose input/output (GPIO) ports of the mainboard expansion slot by a basic input/output system (BIOS); and
setting the configuration of the mainboard expansion slot based on a second preset rule according to the values of the three GPIO ports.

3. The setting method of configuration of mainboard expansion slot according to claim 2, wherein the configuration of the mainboard expansion slot comprises five candidate configurations, the five candidate configurations comprises X16, X8×8, X4×4×8, X8×4×4, and X4×4×4×4, and the configuration of the mainboard expansion slot is one of the five candidate configurations.

4. The setting method of configuration of mainboard expansion slot according to claim 2, wherein the second preset rule is: the configurations X16, X8×8, X4×4×8, X8×4×4, and X4×4×4×4 of the mainboard expansion slot respectively correspond to five different values, each of the five different values is a three-digit binary value, and the value of one of the three GPIO ports is one of the five different values.

5. A setting system of configuration of mainboard expansion slot, comprising:
an automatic setting determination module, configured to determine whether a configuration of a mainboard expansion slot is an automatic setting;
a first setting module, configured to perform the setting of the configuration of the mainboard expansion slot based on a first preset rule when the configuration of the mainboard expansion slot is the automatic setting; and
a second setting module, configured to perform the setting of the configuration of the mainboard expansion slot based on a default value when the configuration of the mainboard expansion slot is not the automatic setting.

6. The setting system of configuration of mainboard expansion slot according to claim 5, wherein the first setting module is further configured to: read values of three general-purpose input/output (GPIO) ports of the mainboard expansion slot by a basic input/output system (BIOS), and set the configuration of the mainboard expansion slot based on a second preset rule according to the values of the three GPIO ports.

7. The setting system of configuration of mainboard expansion slot according to claim 5, wherein the configuration of the mainboard expansion slot comprises five candidate configurations, the five candidate configurations comprises X16, X8×8, X4×4×8, X8×4×4, and X4×4×4×4, and the configuration of the mainboard expansion slot is one of the five candidate configurations.

8. The setting system of configuration of mainboard expansion slot according to claim 6, wherein the second preset rule is: the configurations X16, X8×8, X4×4×8, X8×4×4, and X4×4×4×4 of the mainboard expansion slot respectively correspond to five different values, each of the five different values is a three-digit binary value, and the value of one of the three GPIO ports is one of the five different values.

9. A computer readable medium, stores a computer program, wherein the computer program is executed by a processor to perform the setting method of the configuration of the mainboard expansion slot of claim 1.

10. A computer readable medium, stores a computer program, wherein the computer program is executed by a processor to perform the setting method of the configuration of the mainboard expansion slot of claim 2.

11. A computer readable medium, stores a computer program, wherein the computer program is executed by a processor to perform the setting method of the configuration of the mainboard expansion slot of claim 3.

12. A computer readable medium, stores a computer program, wherein the computer program is executed by a processor to perform the setting method of the configuration of the mainboard expansion slot of claim 4.

13. A setting device of configuration of mainboard expansion slot, comprising:
a memory, configured to store a computer program; and
a processor, connected to the memory, wherein the processor is configured to execute the computer program stored in the memory for the setting device of configuration of mainboard expansion slot to perform the setting method of configuration of mainboard expansion slot of claim 1.

14. A setting device of configuration of mainboard expansion slot, comprising:
a memory, configured to store a computer program; and
a processor, connected to the memory, wherein the processor is configured to execute the computer program stored in the memory for the setting device of configuration of mainboard expansion slot to perform the setting method of configuration of mainboard expansion slot of claim 2.

15. A setting device of configuration of mainboard expansion slot, comprising:
a memory, configured to store a computer program; and
a processor, connected to the memory, wherein the processor is configured to execute the computer program stored in the memory for the setting device of configuration of mainboard expansion slot to perform the setting method of configuration of mainboard expansion slot of claim 3.

16. A setting device of configuration of mainboard expansion slot, comprising:
a memory, configured to store a computer program; and
a processor, connected to the memory, wherein the processor is configured to execute the computer program stored in the memory for the setting device of configuration of mainboard expansion slot to perform the setting method of configuration of mainboard expansion slot of claim 4.
